(19) United States
(12) Patent Application Publication
(10) Pub. No.: US 2010/0163782 A1
(43) Pub. Date: Jul. 1, 2010

(54) Carbon-Containing Metal-Based Composite Material and Manufacturing Method Thereof

(75) Inventors: Chih-Chung Chang, Changhua County (TW); Jenn-Dong Hwang, Hsinchu City (TW); Hsien-Lin Hu, Hsinchu County (TW); Chih-Chung Tu, Hsinchu City (TW)

Correspondence Address: J C PATENTS, 4 VENTURE, SUITE 250, IRVINE, CA, 92618, US

(73) Assignee: Industrial Technology Research Institute, Hsinchu (TW)

(21) Appl. No.: 12/584,377

(22) Filed: Sep. 3, 2009

(30) Foreign Application Priority Data
Dec. 31, 2008 (TW) 97151872

(51) Int. Cl. C09K 5/14

(52) U.S. Cl. 252/71

(57) ABSTRACT

A carbon-containing metal-based composite material and a manufacturing method thereof are provided. The carbon-containing metal-based composite material includes a plurality of graphites, a plurality of heat-conducting reinforcements and a metal matrix. The graphites occupy 35%˜90% in volume. The heat-conducting reinforcements are distributed between the graphites. The heat-conducting reinforcements and the graphites are self-bonded. The heat-conducting reinforcements occupy 5%˜30% in volume and have a thermal conductivity larger than 200 W/mK. The metal matrix is filled between the heat-conducting reinforcements and the graphites, and the metal matrix occupies 5%˜35% in volume.

### CROSS-REFERENCE TO RELATED APPLICATION

This application claims the priority benefit of Taiwan application serial no. 97151872, filed on Dec. 31, 2008. The entirety of the above-mentioned patent application is hereby incorporated by reference herein and made a part of this specification.

### BACKGROUND OF THE INVENTION

1. Field of the Invention

The present invention relates to a carbon-containing metal-based composite material and a manufacturing method thereof. More particularly, the present invention relates to a high thermal conductive carbon-containing metal-based composite material and a manufacturing method thereof.

2. Description of Related Art

As the information technology (IT) advances, various electronic products are developed for high integration, high operation speed, and high performance, etc. Moreover, the design of some electronic products is developed to be light, thin, and compact. In order to satisfy the demands aforementioned, the various electronic devices in the electronic products tend to have higher power dissipation as well as higher heat flux. Thus, the heat dissipation of the electronic devices has become a very important issue in the development of various electronic products, and consequently promotes the rapid development of the thermal management industry.

In general, materials with higher thermal conductivity are usually applied in the electronic devices to improve the heat dissipation property of the electronic devices. To give an example, aluminum and copper, with the respective thermal conductivity of 180 W/mK and 380 W/mK, are usually utilized in the heat dissipation structure designs of the electronic devices. However, materials such as aluminum and copper have high thermal expansion coefficients, thus the reliability of the product must be considered when the materials are actually applied. Furthermore, copper has a large specific density, which causes another problem for the weight of the product. In summary, the materials of monolithic metals can not simultaneously satisfy the characteristics of high thermal conductivity, low thermal expansion, and low bulk density, etc.

### SUMMARY OF THE INVENTION

The present invention provides a carbon-containing metal-based composite material, which provides good heat dissipation in various ways.

The present invention provides a method of manufacturing a carbon-containing metal-based composite material to produce materials with good heat dissipation properties in each direction.

The present invention provides a carbon-containing metal-based composite material, which includes a plurality of graphites, a plurality of heat-conducting reinforcements, and a metal matrix. The graphites occupy 35%˜90% in volume. The heat-conducting reinforcements are distributed between the graphites and self-bonded with the graphites. Here, the heat-conducting reinforcements occupy 5%˜30% in volume, and have a thermal conductivity larger than 200 W/mK. In addition, a metal matrix is filled between the graphites and the heat-conducting reinforcements, and occupies 5%˜35% in volume.

The present invention further provides another method of manufacturing a carbon-containing metal-based composite material. The method includes the following steps. Firstly, a plurality of graphites and a plurality of heat-conducting reinforcements are prepared into a preform. Next, the preform is disposed into a heat insulation protection apparatus. The heat insulation protection apparatus includes a housing and a heat insulation layer. The housing has a passage of the preform and an innerwall. The heat insulation layer is disposed on the inner wall to retain a temperature of the preform. Thereafter, the heat insulation protection apparatus is disposed and heated in a pre-heating furnace. Then, the heat insulation protection apparatus is withdrawn from the pre-heating furnace so that a liquid metal infiltrates into the preform through the inlet passage to form a carbon-containing metal-based composite material.

In light of the foregoing, the carbon-containing metal-based composite material of the present invention utilizes the self-bonding of two different types of materials to enhance the heat-conducting property of the composite material. The types of the two materials are the sheet type and the particle type respectively. The sheet type can provide thermal conductivity in the X-Y planar direction while particles bonded between the graphites can provide higher thermal conductivity in the direction of the Z-axis. Hence, this composite material has good thermal conductivity in various directions. In addition, in the manufacturing method of the carbon-containing metal-based composite material of the present invention, two materials of different types can be self-bonded by the structural property of the graphites. Thus, the step of adding the binder and the cost of the material can be saved.

In order to make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a picture of a carbon-containing metal-based composite material according to an embodiment of the present invention.

FIGS. 2 to 5 are a schematic flow chart of manufacturing the carbon-containing metal-based composite material according to an embodiment of the present invention.

FIG. 6 is a schematic exploded diagram of a heat insulation protection apparatus and a preform in FIG. 3.

### DESCRIPTION OF EMBODIMENTS

In general, although metallic materials can provide reasonable heat-conducting properties, but the metallic materials usually have larger specific density and higher thermal expansion coefficients. Consequently, the weight of electronic products is increased and the reliability of the electronic products is decreased. To solve these problems, techniques of mixing carbon-containing materials, for example, the graphites, with the metal matrix to form the composite material have been proposed. In terms of the graphites, their thermal conductivity can be lied between 200 W/mK˜600 W/mK. Moreover, the graphite material has a low thermal expansion coefficient, so the composite material of graphite-reinforced metal can satisfy the demands on the weight and reliability of the electronic products.

Table 1 shows the heat-conducting property of the carbon-containing metal-based composite material manufactured by mixing the metal matrix and the graphites with different volume ratios.

TABLE 1

| Volume | | Thermal | Thermal |
|---|---|---|---|
| fraction of | Volume | conductivity in | conductivity in the |
| aluminum metal | fraction of | the X-Y plane | direction of the |
| matrix (%) | graphites (%) | (W/mK) | Z-axis (W/mK) |
| 30 | 70 | 505.85 | 96.2 |
| 25 | 75 | 518.55 | 68.79 |
| 20 | 80 | 525.9 | 60.1 |
| 15 | 85 | 585.7 | 53.3 |
| 10 | 90 | 598.8 | 36.0 |

As shown in Table 1, in the carbon-containing metal-based composite material, the higher the graphite content, the higher the thermal conductivity on the X-Y plane is; that is, the better the thermal conductivity on the X-Y plane. However, the thermal conductivity on the Z-axis decreases as the graphite content increases. In practice, the atomic arrangement of the graphite represents a specific arrangement, thus the physical property thereof will also represent a specific anisotropy. To give an example, when the graphites are pressured in mold, each of the graphites will be aligned in parallel to a direction that is perpendicular to the force exerted. In other words, the graphites are arranged in parallel along the X-Y plane. At this time, the heat-conducting property of the graphite will represent a strong anisotropy.

Thus, if the carbon-containing metal-based composite material is merely a mixture of the graphites and the metal matrix, the material will not have a good heat-conducting property in every direction. It should be noted that the thermal conductivity of the mixture with only the graphites and the metal material is far lower in the Z-axis direction than that in the X-Y plane. Thus, the present invention proposes a technique of adding the heat-conducting reinforcements to the carbon-containing metal-based composite material other than the graphites. Consequently, the carbon-containing metal-based composite material not only has high thermal conductivity in the X-Y planar direction, but also has good thermal conductivity in the Z-axis direction, which is perpendicular to the X-Y plane. That is, the carbon-containing metal-based composite material will have an isotropic heat-conducting property.

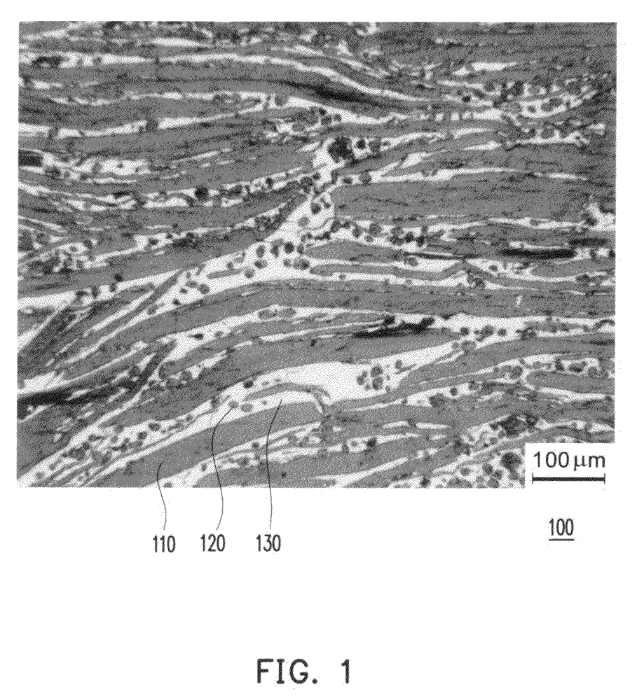

FIG. 1 is a picture of a carbon-containing metal-based composite material according to an embodiment of the present invention. Referring to FIG. 1, a carbon-containing metal-based composite material 100 includes a plurality of graphites 110, a plurality of heat-conducting reinforcements 120, and a metal matrix 130. The heat-conducting reinforcements 120 are distributed between the graphites 110, and the graphites 110 are self-bonded with the heat-conducting reinforcements when they are molded in a preform 120. Here, the thermal conductivity of the heat-conducting reinforcement 120 is larger than 200 W/mK. The metal matrix 130 is filled between the graphites 110 and the heat-conducting reinforcements 120. Moreover, a material of the metal matrix 130 includes copper, cooper alloy, aluminum, aluminum alloy, silver, silver alloy, magnesium, magnesium alloy or a combination thereof.

In the carbon-containing metal-based composite material 100, the graphites 110 occupy 35%˜90% in volume, where the preferred volume fraction is 39%˜81%. The heat-conducting reinforcements 120 occupy 5%˜35% in volume, where the preferred volume fraction is 8%˜26%. On the other hand, the metal matrix 130 occupies 5%˜35% in volume with the preferred volume fraction of 10%˜35%. Comparing with the graphites in flake type, the heat-conducting reinforcements 120 are, for example, particles with smaller volume. Moreover, the heat-conducting reinforcements 120 can be distributed in the gaps between the graphites 110. In addition, the thermal conductivity of the heat-conducting reinforcements 120 is larger than 200 W/mK, so the disposition of the heat-conducting reinforcements 120 helps to increase the heat-conducting property of the carbon-containing metal-cased composite material 100 in the Z-axis direction. Furthermore, the heat-conducting reinforcements 120 include powder materials or milled carbon fibers.

Specifically, when the heat-conducting reinforcements 120 in the carbon-containing metal-based composite material 100 are of the powder materials, the particle sizes can range from 10 μm to 500 μm. The powder materials aforementioned can be graphite powders, mesocarbon micro-beads (MCMBs), carbon black, diamond powders, ceramic powders, metal powders, or a combination thereof. Herein, a material of the ceramic powders includes silicon carbide (SiC), diamond-like carbon (DLC), silicon nitride (Si₃N₄), aluminum nitride (AlN), boron nitride (BN), or a combination thereof. Additionally, the graphitization degree of the graphite powders is larger than 70%, for instance. Besides, if the powder material applied is the metal powders, then the metal powders and the metal matrix 130 will be different metals. Preferably, the melting point of the metal powders used is greater than the melting point of the metal matrix 130.

In the carbon-containing metal-based composite material 100, if the heat-conducting reinforcements 120 are the milled carbon fibers, the aspect ratio of the milled carbon fibers is no greater than 100. To give an example, the milled carbon fibers can be a vapor grown carbon fibers (VGCF) or other pitch-based and PAN-based milled carbon fibers. Here, the diameter of the carbon fibers ranges from 1 μm to 50 μm, and a length of the carbon fibers ranges from 10 μm to 500 μm. Obviously, the material, size, and type of the heat-conducting reinforcements 120 are merely exemplary, and the present invention is not limited thereto.

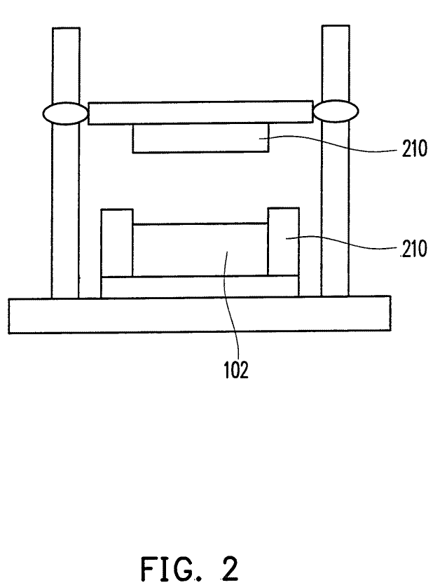

In order to further illustrate the carbon-containing metal-based composite material 100 of the present invention, a method of manufacturing the carbon-containing metal-based composite material 100 is illustrated as follows. FIGS. 2 to 5 are a schematic flow chart of manufacturing the carbon-containing metal-based composite material according to an embodiment of the present invention. Referring to FIG. 2, firstly, the graphites and the heat-conducting reinforcements are prepared into a preform 102. The graphites and the heat-conducting reinforcements in the preform 102 are very subtle structures, and thus are not labeled in FIG. 2. In one embodiment, the method of fabricating the preform 102 includes mixing the graphites and the heat-conducting reinforcements uniformly, and disposing the mixture into a mold 210. Next, a pressure is exerted so that the graphites are self-bonded with the heat-conducting reinforcements to form the preform 102. Here, the pressure exerted is greater than 50 kg/cm².

It should be noted that in the pressurizing process aforementioned, the graphites will be aligned in a direction perpendicular to the direction of the pressure exerted, and the heat-conducting reinforcements can be rolled in the gaps between the graphites. In addition, the graphites subjected to special treatment will generate self-bonding property under high pressure, so that the graphites are self-bonded with the heat-conducting reinforcements. That is, the graphites and the heat-conducting reinforcements can be self-bonded to form the preform 102 without additional binders. In other words, the use of binders and steps related thereto can be saved in the present embodiment.

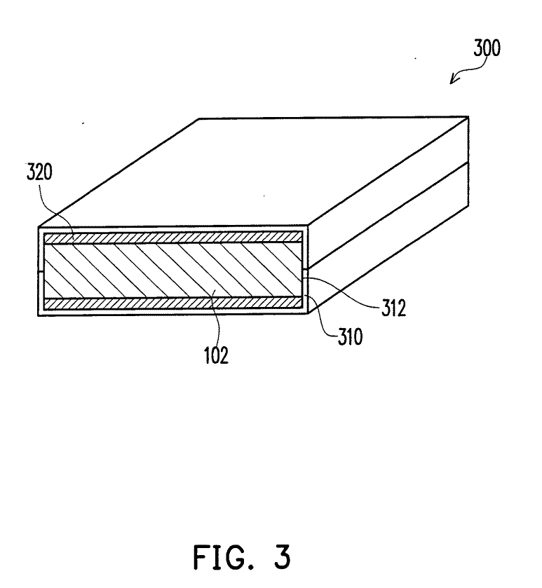

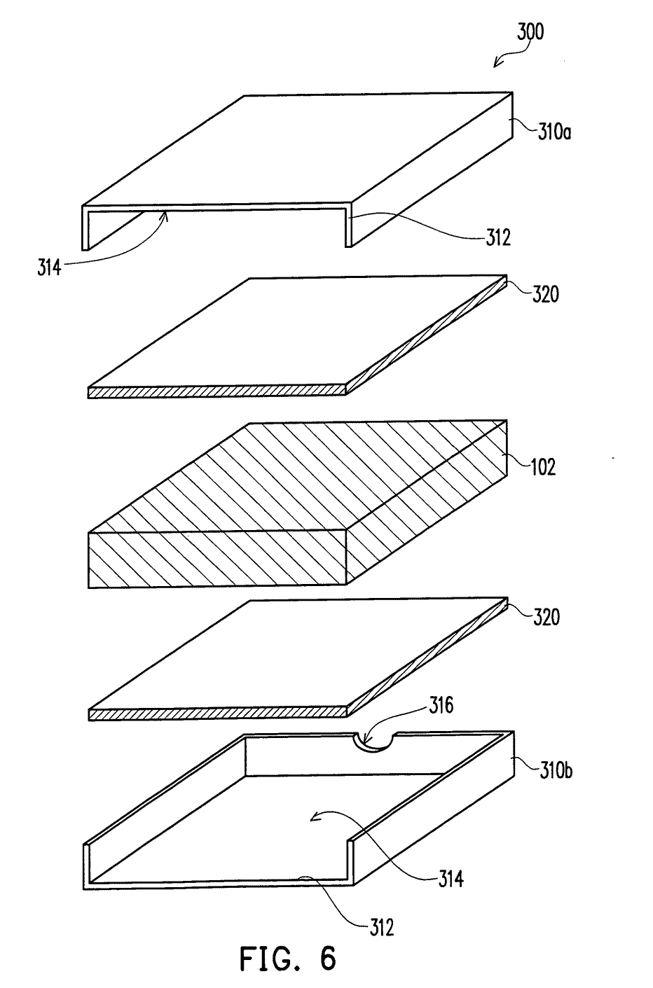

Next, referring to FIG. 3, the preform 102 is disposed into a heat insulation protection apparatus 300. The heat insulation protection apparatus 300 includes a housing 310 and a heat insulation layer 320. In detail, referring to FIG. 6, which is a schematic explosion diagram of the preform 102, disposed into the heat insulation protection apparatus 300 in FIG. 3. The housing 310 is assembled by an upper cover 310a and a lower cover 310b. The upper cover 310a and the lower cover 310b each has an inner wall 314 and a passage 312 used to dispose the preform 102.

The heat insulation layers 320 are disposed on the inner walls 314 of the upper cover 310a and the lower cover 310b to retain the temperature of the preform 102 as it is withdrawn from the pre-heating furnace and inserted into the mold cavity. Herein, the material of the heat insulation layer 320 can be aluminum oxide (Al₂O₃), zirconium oxide (ZrO₂), silicon oxide (SiO₂), silicon nitride (Si₃N₄), aluminum nitride (AlN), boron nitride (BN), or ceramic fiber cloth.

In the present embodiment, the housing 310 further includes a gas vent 316 relative to the inlet passage 312. Moreover, a material of the housing 310 includes iron-based metal, cobalt-based metal, nickel-based metal, or ceramic material. The housing 310 has the function of supporting the preform 102, and the design of the housing 310 allows the preform 102 to be accessed easily, so that the automation of the process is facilitated.

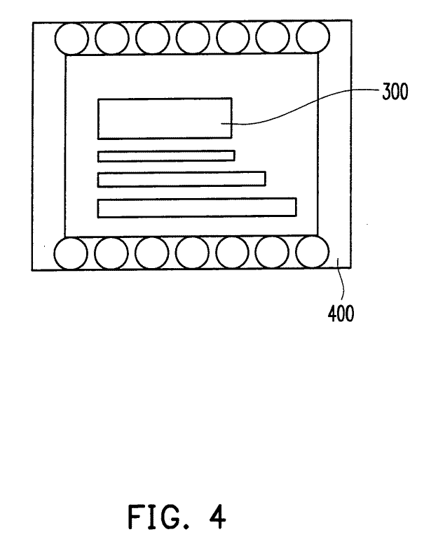

FIG. 4 is referred to the subsequent step illustrated in FIG. 3; that is, after the preform 102 is disposed into the heat insulation protection apparatus 300. Here, the heat insulation protection apparatus 300 disposed with the preform 102 is subject to the pre-heating furnace 400 under inert gas. In the present embodiment, the heating step performed in the pre-heating furnace 400 has the temperature ranging from 500 to 800° C.

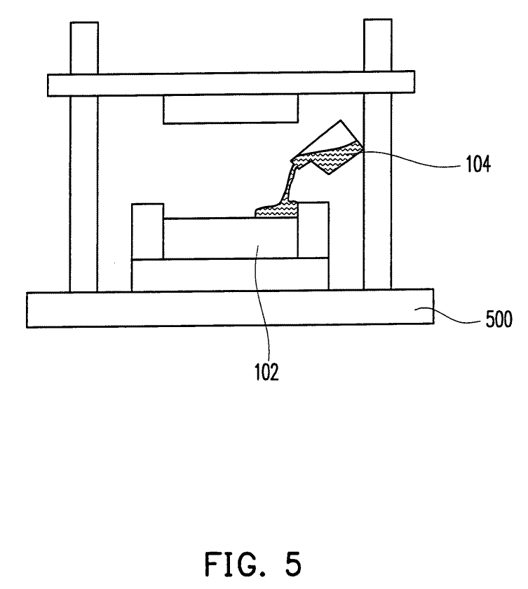

Next, referring to FIG. 4 and FIG. 5 simultaneously, the heat insulation protection apparatus 300 is withdrawn from the pre-heating furnace 400 and disposed in a liquid infiltration apparatus 500. Thereafter, the metal matrix 104 is infiltrated into the preform 102 through the passage 312 of the housing 310 in the heat insulation protection apparatus 300 (as shown in FIG. 3 and FIG. 6), so that the carbon-containing metal-based composite material 100 shown in FIG. 1 is formed.

It should be noted that in the step of FIG. 5, as the inner wall of the housing in the heat insulation protection apparatus 300 is disposed with the heat insulation layer, the temperature of the preform 102 can be maintained after the withdrawal from the pre-heating furnace with inert gas. Hence, the infiltration of the metal matrix 104 into the preform 102 is facilitated. At the same time, in the process of the metal matrix 104 infiltrating into the interior of the preform 102, the air originally present in the preform 102 can be extruded along the gas vent 316 of the housing 310 of the heat insulation protection apparatus 300 (as illustrated in FIG. 3 and FIG. 6). Therefore, the design of the heat insulation protection apparatus 300 can increase the process yield of the carbon-containing metal-based composite material 100. Moreover, under the protection of the heat insulation protection apparatus 300, the preform 102 will not contact with air directly so as to avoid high temperature oxidation. Thus, the quality of the carbon-containing metal-based composite material 100 can be further elevated.

In the carbon-containing metal-based composite material 100, the graphites occupy approximately 35%˜90% in volume, the heat-conducting reinforcements occupy approximately 5%˜30% in volume, and the metal matrix occupies about 5%˜35% in volume. Under various demands, the ratio of the graphites, the heat-conducting reinforcements, and the metal matrix in the carbon-containing metal-based composite material 100 can have variations. Several examples are listed below to further illustrate the carbon-containing metal-based composite material 100 of the present invention.

### First Example

Firstly, the preform using the graphites and the mesocarbon microbeads (MCMBs) is prepared. Here, the graphites and the mesocarbon micro-beads are mixed in a ratio of 9:1 in weight. That is, the present example utilizes the mesocarbon micro-beads as the heat-conducting reinforcements. The uniformly mixed graphites and mesocarbon micro-beads are pressured by a pressure greater than 50 kg/cm² to form the preform. As illustrated above, the graphites generate the self-bonding property under high pressure such that the graphites are self-bonded with the mesocarbon micro-beads. In other words, no other binders are required in the present example to bond the graphites and the mesocarbon micro-beads to form the preform. Obviously, the pressure exerted to form the preform is not limited to the value illustrated in the present example.

Next, after the preform is pressured and formed, the preform is disposed in the heat insulation protection apparatus and heated in the pre-heating furnace to 700° C. In the present example, the heating temperature of the pre-heating furnace is merely exemplary, and other temperatures may be used in other examples.

Thereafter, the preform disposed in the heat insulation protection apparatus is withdrawn from the pre-heating furnace, so that the melting aluminum alloy (for example, aluminum-silicon alloy) is infiltrated into the interior of the preform. The casting conditions of infiltrating the aluminum alloy melt into the interior of the preform, for example, are the plunger speed greater than 0.7 m/min, and maintaining the liquid infiltration pressure above 800 kg/cm². Under such manufacturing conditions, a carbon-containing metal-based composite material having a metal base of the aluminum alloy is formed. In the present example, the metal matrix occupies about 20% in volume of the carbon-containing metal-based composite material. The preform composed by the graphites and the mesocarbon micro-beads occupies approximately 80% in volume. That is, the graphites occupy 72% in volume, and the mesocarbon micro-beads occupy 8% in volume of the carbon-containing metal-based composite material. Furthermore, for the carbon-containing metal-based composite material illustrated in the first example, the thermal conductivity in the Z-axis direction can reach 157.3 W/mK, and the thermal conductivity in the X-Y plane is approximately 453.9 W/mK.

### Second Example

In the second example, the milled carbon fibers are used as the heat-conducting reinforcements to form the preform with the graphites. Here, the aspect ratio of the milled carbon fibers is not greater than 100. In the second example, the graphites and the milled carbon fibers are mixed in a ratio of 9:1 to form the preform. Here, the preparation condition of the preform is the same as that of the first example. Moreover, the formation of the carbon-containing metal-based composite material from the preform of the second example applies the same preparation condition as that of the first example. In the carbon-containing metal-based composite material of the second example, the metal matrix occupies approximately 20% in volume of the carbon-containing metal-based composite material. The preform occupies 80% in volume of the carbon-containing metal-based composite material; that is, the graphites occupy 72% in volume and the milled carbon fibers occupy approximately 8% in volume of the carbon-containing metal-based composite material. Hence, for the carbon-containing metal-based composite material illustrated in second example, the thermal conductivity in the Z-axis direction is approximately 178.7 W/mK, and the thermal conductivity in the X-Y plane is approximately 435.6 W/mK.

### Third Example

In the third example, the preform with the graphites and the diamond powders is prepared, where the graphites and the diamond powders are mixed in a ratio of 8:2. The third example, for example, applies the same preparation condition as that of the first example to form the carbon-containing metal-based composite material. Thus, the description of the preparation condition is omitted herein. In the present example, the metal matrix occupies about 20% in volume of the carbon-containing metal-based composite material. On the other hand, the preform occupies 80% in volume of the carbon-containing metal-based composite material; that is, the graphites occupy 64% in volume and the diamond powders occupy approximately 16% in volume of the carbon-containing metal-based composite material. It should be noted that for the carbon-containing metal-based composite material illustrated in the third example, the thermal conductivity in the Z-axis direction can reach 209.5 W/mK, and the thermal conductivity in the X-Y plane is approximately 476.4 W/mK. In comparison with the first example, the heat-conducting reinforcements in the third example, that is, the diamond powders, have a higher thermal conductivity, thus the thermal conductivity in the Z-axis direction is also increased.

### Fourth Example

In the fourth example, the preform using the graphites and mesocarbon micro-beads is prepared. Here, the graphites and the mesocarbon microbeads are mixed in a ratio of 9:1. The fourth example, for example, applies the same preparation condition as that of the first example to form the carbon-containing metal-based composite material. Thus, the description of the preparation condition is omitted herein. Also, in the present example, the metal matrix occupies about 10% in volume of the carbon-containing metal-based composite material. On the other hand, the preform occupies 90% in volume of the carbon-containing metal-based composite material. That is, the graphites occupy 81% in volume and the mesocarbon microbeads occupy approximately 9% in volume of the carbon-containing metal-based composite material. It should be noted that for the carbon-containing metal-based composite material illustrated in the fourth example, the thermal conductivity in the Z-axis direction can reach 167.4 W/mK, and the thermal conductivity in the X-Y plane is approximately 463.7 W/mK.

### Fifth Example

In the fifth example, the preform using the graphites and the mesocarbon micro-beads is prepared. Here, the graphites and the mesocarbon microbeads are mixed in a ratio of 6:4. The fifth example, for example, applies the same preparation condition as that of the first example to manufacture the carbon-containing metal-based composite material. Thus, the description of the preparation condition is omitted herein. Also, in the present example, the metal matrix occupies about 35% in volume of the carbon-containing metal-based composite material. On the other hand, the preform occupies 65% in volume of the carbon-containing metal-based composite material. That is, the graphites occupy 39% in volume and the mesocarbon micro-beads occupy approximately 26% in volume of the carbon-containing metal-based composite material. It should be noted that for the carbon-containing metal-based composite material illustrated in the fifth example, the thermal conductivity in the Z-axis direction can reach 117.6 W/mK, and the thermal conductivity in the X-Y plane is approximately 362.3 W/mK.

### Comparative Example

In order to further illustrate the heat-conducting property of carbon-containing metal-based composite material of the present invention, a preform only prepared with the graphite is used as a comparative example. That is, the preform in the comparative example is assembled by the graphites of a single type while no heat-conducting reinforcements are included. The comparative example with the graphite prepared preform also applies the same preparation steps as that of the first example to form the carbon-containing metal-based composite material. In the comparative example, the carbon-containing metal-based composite material has the thermal conductivity of approximately 60.1 W/mK in the Z-axis direction, and has the thermal conductivity of approximately 525.9 W/mK in the X-Y plane. Table 2 represents the characteristics of the examples aforementioned and the comparative example to illustrate the heat-conducting property of the carbon-containing metal-based composite material of the present invention.

TABLE 2

| | | | | | Thermal |
|---|---|---|---|---|---|
| | | | | Thermal | conductivity |
| | | | | conductivity | in the |
| | | | Preform | in the X-Y | direction of |
| | | Preform | Density | plane | the Z axis |
| | Metal Matrix | Component | (g/cc) | (W/m · K) | (W/m · K) |
| Comparative | 20% | 80% graphites | 2.09 | 525.9 | 60.1 |
| Example | Aluminum | | | | |
| | alloy | | | | |
| First | 20% | 80% graphites | 2.361 | 453.9 | 157.3 |
| Example | Aluminum | and mesocarbon | | | |
| | alloy | micro-beads | | | |
| | | (9:1) | | | |
| Second | 20% | 80% graphites | 2.342 | 435.6 | 178.7 |
| Example | Aluminum | and milled | | | |
| | alloy | carbon fibers | | | |
| | | (9:1) | | | |
| Third | 20% | 80% graphites | 2.543 | 476.4 | 209.5 |
| Example | Aluminum | and diamond | | | |
| | alloy | powders | | | |
| Fourth | 10% | 90% graphites | 2.263 | 463.7 | 167.4 |
| Example | Aluminum | and mesocarbon | | | |
| | alloy | micro-beads | | | |
| | | (9:1) | | | |
| Fifth | 35% | 65% graphites | 2.378 | 362.3 | 117.6 |
| Example | Aluminum | and mesocarbon | | | |
| | alloy | micro-beads | | | |
| | | (6:4) | | | |

As illustrated in Table 2, the thermal conductivity of the comparative example in the Z-axis direction is far smaller than those of the aforementioned examples. In other words, the carbon-containing metal-based composite material obtained from the preform of the graphites has an obvious anisotropy in the thermal conductivity. When materials as such are utilized in actual products, the heat-conducting property and consequently the quality of the products may be adversely affected. The heat-conducting properties illustrated from the first example to the fifth example show that the addition of the heat-conducting reinforcements into the preform can greatly increase (about 2.5˜3 times higher) the heat-conducting property of the carbon-containing metal-based composite material in the Z-axis direction. In other words, the carbon-containing metal-based composite material in the present invention not only omits additional binders but also has a more isotropic heat-conducting property.

In the above embodiments, the carbon-containing metal-based composite material is formed using the metal matrix and the preform of the same ratio. However, the substantial volume ratio of the metal matrix and the preform may be changed or modified according to the demands of various products. Furthermore, the mesocarbon micro-beads and the milled carbon fibers are as examples of the heat-conducting reinforcements in the examples aforementioned. However, other ceramic materials, carbon fibers, or other powder materials can also be selected as the heat-conducting reinforcements in other embodiments. Thus, the present invention should not be construed as limited to the embodiments set forth herein.

In summary, the carbon-containing metal-based composite material of the present invention applies the graphites and the heat-conducting reinforcements to increase the thermal conductivity of the composite material. The composite material of the present invention can provide good thermal conductivity in various ways, so that the carbon-containing metal-based composite material can have good quality and wider application scope. In addition, the graphites have the self-bonding property under high-pressure, so the manufacturing method of the carbon-containing metal-based composite material of the present invention does not require extra binders to bond graphites and the heat-conducting reinforcements. Hence, the steps and cost of material for the bonding can be saved. As a consequence, the method of manufacturing the carbon-containing metal-based composite material of the present invention can be more simplified and less costly than the conventional steps.

Although the present invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A carbon-containing metal-based composite material comprises:
a plurality of graphites, occupying 35%˜90% in volume;
a plurality of heat-conducting reinforcements, distributed between the plurality of graphites and self-bonded with the plurality of graphites, wherein the plurality of heat-conducting reinforcements occupy 5%˜30% in volume, and the plurality of heat-conducting reinforcements have a thermal conductivity larger than 200 W/mK; and
a metal matrix, filled between the plurality of graphites and the plurality of heat-conducting reinforcement, and occupying 5%˜35% in volume.

2. The carbon-containing metal-based composite material as claimed in claim 1, wherein the plurality of heat-conducting reinforcements comprises a plurality of powder materials.

3. The carbon-containing metal-based composite material as claimed in claim 2, wherein the diameter of the plurality of powder materials ranges from 5 μm to 500 μm.

4. The carbon-containing metal-based composite material as claimed in claim 2, wherein the plurality of powder materials comprises graphite powders, mesocarbon micro-beads (MCMB), carbon black, diamond powders, ceramic powders, metal powders, or a combination thereof.

5. The carbon-containing metal-based composite material as claimed in claim 4, wherein a material of the ceramic powders comprises silicon carbide, diamond powder, silicon nitride, aluminum nitride, boron nitride, or a combination thereof.

6. The carbon-containing metal-based composite material as claimed in claim 4, wherein a graphitization degree of the graphite powders is larger than 65%.

7. The carbon-containing metal-based composite material as claimed in claim 4, wherein the metal powders and the metal matrix are different metals.

8. The carbon-containing metal-based composite material as claimed in claim 1, wherein the heat-conducting grain comprises carbon fibers with an aspect ratio not greater than 100.

9. The carbon-containing metal-based composite material as claimed in claim 8, wherein the carbon fibers comprises vapor grown carbon fibers or pitch-based carbon fibers.

10. The carbon-containing metal-based composite material as claimed in claim 8, wherein a diameter of the carbon fibers ranges from 1 μm to 50 μm, and a length of the carbon fibers ranges from 5 μm to 500 μm.

11. The carbon-containing metal-based composite material as claimed in claim 1, wherein a material of the metal matrix comprises copper and copper alloy, aluminum and aluminum alloy, silver and silver alloy, magnesium and magnesium alloy, thereof.

12. A method of manufacturing a carbon-containing metal-based composite material, the method comprises:
preparing a plurality of graphites and a plurality of heat-conducting reinforcements into a preform;
disposing the preform into a heat insulation protection apparatus, wherein the heat insulation protection apparatus comprises:
a housing, having a inlet passage of the preform and an inner wall; and
a heat insulation layer, disposed on the inner wall to retain a temperature of the preform;
disposing the heat insulation protection apparatus in a pre-heating furnace to be heated; and
withdrawing the heat insulation protection apparatus from the pre-heating furnace and infiltrating a metal matrix into the preform through the inlet passage to form a carbon-containing metal-based composite material.

13. The method of manufacturing the carbon-containing metal-based composite material as claimed in claim 12, wherein a method of preparing the preform comprises mixing the plurality of graphites and the plurality of heat-conducting reinforcements uniformly, and exerting a pressure so that the plurality of graphites and the plurality of heat-conducting reinforcements are self-bonded to form the preform.

14. The method of manufacturing the carbon-containing metal-based composite material as claimed in claim 12, wherein the housing further comprises a gas vent relative to the inlet passage, so an internal gas in the preform is emitted when the liquid metal is infiltrated into the preform.

15. The method of manufacturing the carbon-containing metal-based composite material as claimed in claim 12, wherein the plurality of graphites occupies 35%˜90% in volume of the carbon-containing metal-based composite material.

16. The method of manufacturing the carbon-containing metal-based composite material as claimed in claim 12, wherein the plurality of heat-conducting reinforcements occupies 5%˜30% in volume of the carbon-containing metal-based composite material.

17. The method of manufacturing the carbon-containing metal-based composite material as claimed in claim 12, wherein the metal matrix occupies 5%˜35% in volume of the carbon-containing metal-based composite material.

18. The carbon-containing metal-based composite material as claimed in claim 12, wherein a material of the metal matrix comprises copper, and copper alloy, aluminum, and aluminum alloy, silver and silver alloy, magnesium and magnesium alloy, and so on.

19. The carbon-containing metal-based composite material as claimed in claim 12, wherein the housing comprises an iron-based metal, a cobalt-based metal, a nickel-based metal, or a ceramic material.
